(19) United States
(12) Patent Application Publication
(10) Pub. No.: US 2025/0182201 A1
(43) Pub. Date: Jun. 5, 2025

(54) System and Method for Dynamic Adjustment of Graphical User Interface for Improved Model Selection

(71) Applicant: David B. Coulter, Tustin, CA (US)

(72) Inventor: David B. Coulter, Tustin, CA (US)

(21) Appl. No.: 18/952,956

(22) Filed: Nov. 19, 2024

Related U.S. Application Data
(63) Continuation of application No. 17/714,929, filed on Apr. 6, 2022, now abandoned.
(60) Provisional application No. 63/171,482, filed on Apr. 6, 2021.

(51) Int. Cl. G06Q 40/03; G06Q 30/08

(52) U.S. Cl. CPC G06Q 40/03; G06Q 30/08

(57) ABSTRACT

Embodiments disclosed herein are directed to a computerized method that includes operations of generating a graphical user interface (GUI) displaying parameters of a financial objective and a plurality of financial model icons, wherein each of the plurality of financial model icons lists a credit score and a corresponding payment and receiving, by the GUI, user input modifying a first parameter of the financial objective. Additional operations include dynamically updating one or more of the plurality of financial model icons, and altering the GUI based on the dynamically updating of the plurality of financial model icons resulting in an adjustment of a positioning of a first financial model icon. Adjustment of the positioning of the first financial model icon may include positioning the first financial model icon proximate the first parameter, wherein an advantage provided by a first financial model represented by the first financial model icon corresponds the first parameter.

### RELATED APPLICATIONS

This application is a continuation of U.S. application Ser. No. 17/714,929, filed Apr. 6, 2022, which claims the benefit of priority to U.S. Provisional Application No. 63/171,482, filed Apr. 6, 2021, each of which are incorporated by reference in their entirety into this application.

The following patents and publications are related to the subject matter of this application and are incorporated by reference in their entireties into this application: U.S. Pat. Nos. 7,818,228, 7,877,304, 8,285,613, US 2011/0166988, U.S. Pat. No. 11,232,489, US 2020/0074546, US 2021/0233166, and U.S. patent application Ser. No. 17/705,152 filed Mar. 25, 2022.

### SUMMARY

Embodiments disclosed herein are directed to a loan access system and associated methods thereof. The loan access system can be configured to determine a current financial information, and to determine a financial objective, for a user. The system can determine financial objective parameters that can be further modified by the user. The system can then provide a platform for one or more lenders to provide a loan product that can fulfill the financial objective parameters. Either the system can review existing loan products, or the system can provide an auction platform for one or more lenders to bid for the loan product(s). The system can then provide the one or more loan products, provided by one or more lenders, to the user. If the loan is available with the user's current financial information, the user can either apply for the loan immediately, or can modify the financial objective parameters.

In an embodiment, the system can provide a financial model wherein one or more of the loans can become available to the user within a predetermined time window. The system can determine a personalized financial model for the user that can modify the user's current financial information to a future, predetermined financial information and within a predetermined time window. The future predetermined financial information can allow the user to apply for the loan, that was previously inaccessible, and finance the financial objective. In this way the system can a map out a path or “journey” for the user from their current financial situation to a future financial situation and on to achieve their financial objectives.

Advantageously, the system can plan out financial objectives that can become possible within the predetermined time window. The system can motivate a user to modify their current financial information to a future, predetermined financial information by showing a user what can be possible to achieve along the way. Further the system can provide a financial model and a time frame within which to achieve the future financial information and thereby achieve the loan and finance the financial objective, completing their journey.

During the predetermined time window the system can review changes to the user's current financial information to determine if the financial model is being implemented correctly and if the financial model is having the expected effect on the user's current financial information. If not, the system can course-correct the user and modify the financial model and/or the financial objective parameters and associated loan products. In an embodiment, the system can implement the financial model autonomously, semi-autonomously, or can provide the financial model to the user to implement. Over the course of the journey the system can provide tips, education, or motivation to the user, which can be linked with changes in user's financial information. Further, over the course of the journey, the system can request updates to personal and financial information.

In an embodiment, the financial model can be determined by machine learning or similar artificial intelligence schema, which are trained from previous financial objectives, associated parameters, and financial models, from the user or one or more second users of the system who are unrelated to the first user. Advantageously, the system can remove PII information from the one or more second users of the system before using the data to determine the model for the first user. This maintains the privacy of the first user and/or second users of the system while leveraging the personal or financial aspects of the model(s) that were successful and improving the accuracy of future financial models.

Disclosed herein is a method of accessing a loan including, providing a user interface including a current financial information for a first user, responsive to an input selecting a financial objective having one or more parameters, generating a financial model including processing the current financial information, a future financial information, and the one or more financial objective parameters, with a machine learning model that is trained, in part using information from one or more second users to determine, i) key feature vectors from the current financial information, the future financial information, and the one or more financial objective parameters, and ii) determine, based in part on the key feature vectors, a series of actions steps to modify the current financial information to the future financial information, and financing the financial objective within the one or more parameters based on the future financial information.

In some embodiments, the current financial information includes one of a current income, a current expenditure, a current asset, a current liability or a current credit score, and wherein the future financial information include one of a future income, a future expenditure, a future asset, a future liability or a future credit score.

In some embodiments, the financial objective includes one of a house, a car, a personal loan, or a credit card.

In some embodiments, the one or more financial objective parameters includes one or more of a total value of the financial objective, a down payment amount, an annual percentage rate, an interest rate, financial objective target date, a monthly payment which includes a principal payment and an interest rate payment, a maximum time to repay, a minimum payment.

In some embodiments, the information from one or more second users includes one or more of a personal information, a current financial information for the second user, a future financial information for the second user, a financial objective, one or more key feature vectors, and a financial model from a second user different from the first user.

In some embodiments, financing the financial objective includes selecting a loan from one or more loan products provided by one or more lenders.

In some embodiments, financing the financial objective includes establishing an online auction platform for one or more lenders to bid for a loan to finance the financial objective within the one or more parameters.

In some embodiments, financing the financial objective includes determining that the current financial information matches the future financial information and applying for a loan from one or more loan products provided by one or more lenders.

In some embodiments, the method further includes receiving an input to modify the one or more parameter of the financial objective.

In some embodiments, the method further includes providing a first financial model summary for a first financial model and a second financial model summary for a second financial model, the first financial model summary or the second financial model summary including one of the future financial information, the one or more financial objective parameter, or a comparison information between the first financial model and the second financial model.

In some embodiments, the method further includes responsive to selection of a hyperlink within the financial model, sending and receiving instructions to or from a third party to implement an action step of the financial model.

Also disclosed is a non-transitory computer readable medium, when read by one or more processors of a server, cause the one or more processors to execute, a financial objective logic configured to receive a selection of a financial objective, and receive one or more financial objective parameters, a financial model logic configured to generate a financial model including processing a current financial information, a future financial information, and the one or more financial objective parameters, with a machine learning model that is trained, in part using information from one or more second users to determine, i) key variables from the current financial information, the future financial information, and the one or more financial objective parameters, and ii) determine, based in part on the key variables, a series of actions steps to modify the current financial information to the future financial information, and a loan procurement logic configured to finance the financial objective within the one or more financial objective parameters based on the future financial information.

In some embodiments, the non-transitory computer readable medium further includes a user profile logic configured to retrieve the current financial information for the first user from one or more remote data stores and configured to receive an input corresponding to a future financial information.

In some embodiments, the current financial information includes one of a current income, a current expenditure, a current asset, a current liability or a current credit score, and wherein the future financial information include one of a future income, a future expenditure, a future asset, a future liability or a future credit score.

In some embodiments, the financial objective includes one of a house, a car, a personal loan, or a credit card.

In some embodiments, the one or more financial objective parameters includes one or more of a total value of the financial objective, a down payment amount, an annual percentage rate, an interest rate, financial objective target date, a monthly payment which includes a principal payment and an interest rate payment, a maximum time to repay, a minimum payment.

In some embodiments, information from one or more second users includes one or more of a personal information, a current financial information, a future financial information, a financial objective, one or more key variables, and a financial model, from a second user that is different from the first user.

In some embodiments, the loan procurement logic is configured to select a loan from one or more loan products provided by one or more lenders.

In some embodiments, the loan procurement logic is configured to establish an online auction platform for one or more lenders to bid for a loan to finance the financial objective within the one or more parameters.

In some embodiments, the loan procurement logic is configured to determine that the current financial information matches the future financial information and apply for a loan from one or more loan products provided by one or more lenders.

In some embodiments, the financial model logic is further configured to provide a first financial model summary for a first financial model and a second financial model summary for a second financial model, the first financial model summary or the second financial model summary including one of the future financial information, the one or more financial objective parameter, or a comparison information between the first financial model and the second financial model.

In some embodiments, the financial model logic is further configured receive a selection of a hyperlink provided within the financial model, and configured to send and receive instructions to or from a third party to implement an action step of the financial model.

Also disclosed is a network device including, one or more processors, and memory communicatively coupled with the one or more processors, the memory comprises machine readable instructions that when executed by the one or more processors, cause the one or more processors to execute, a financial objective logic configured to receive a selection of a financial objective, and receive one or more financial objective parameters, a financial model logic configured to generate a financial model including processing a current financial information, a future financial information, and the one or more financial objective parameters, with a machine learning model that is trained, in part using information from one or more second users to determine, i) key variables from the current financial information, the future financial information, and the one or more financial objective parameters, and ii) determine, based in part on the key variables, a series of actions steps to modify the current financial information to the future financial information, and a loan procurement logic configured to finance the financial objective within the one or more financial objective parameters based on the future financial information.

In some embodiments, the network device further includes a user profile logic configured to retrieve the current financial information for the first user from one or more remote data stores and configured to receive an input corresponding to a future financial information.

In some embodiments, the current financial information includes one of a current income, a current expenditure, a current asset, a current liability or a current credit score, and wherein the future financial information include one of a future income, a future expenditure, a future asset, a future liability or a future credit score.

In some embodiments, the financial objective includes one of a house, a car, a personal loan, or a credit card.

In some embodiments, the one or more financial objective parameters includes one or more of a total value of the financial objective, a down payment amount, an annual percentage rate, an interest rate, financial objective target date, a monthly payment which includes a principal payment and an interest rate payment, a maximum time to repay, a minimum payment.

In some embodiments, information from one or more second users includes one or more of a personal information, current financial information, future financial information, a financial objective, one or more key variables, and a financial model from a second user different from the first user.

In some embodiments, the loan procurement logic is configured to select a loan from one or more loan products provided by one or more lenders.

In some embodiments, the loan procurement logic is configured to establish an online auction platform for one or more lenders to bid for a loan to finance the financial objective within the one or more parameters.

In some embodiments, the loan procurement logic is configured to determine that the current financial information matches the future financial information and apply for a loan from one or more loan products provided by one or more lenders.

In some embodiments, the financial model logic is further configured to provide a first financial model summary for a first financial model and a second financial model summary for a second financial model, the first financial model summary or the second financial model summary including one of the future financial information, the one or more financial objective parameter, or a comparison information between the first financial model and the second financial model.

In some embodiments, the financial model logic is further configured receive a selection of a hyperlink provided within the financial model and configured to send and receive instructions to or from a third party to implement an action step of the financial model.

### BRIEF DESCRIPTION OF THE DRAWINGS

To further clarify embodiments of the disclosure, a more particular description will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary architecture of a system, in accordance with embodiments disclosed herein.

FIGS. 2A-2B illustrates a flow chart for an exemplary method of use, in accordance with embodiments disclosed herein.

FIG. 3 illustrates an exemplary screenshot of a user profile interface of the system of FIG. 1, in accordance with embodiments disclosed herein.

FIG. 4 illustrates an exemplary screenshot of a financial objective interface of the system of FIG. 1, in accordance with embodiments disclosed herein.

FIG. 5 illustrates an exemplary screenshot of a financial model interface of the system of FIG. 1, in accordance with embodiments disclosed herein.

FIG. 6A illustrates an exemplary screenshot of the system of FIG. 1 as shown on a mobile device, in accordance with embodiments disclosed herein.

FIG. 6B illustrates an exemplary screenshot of the system of FIG. 1 as shown on a computing device, in accordance with embodiments disclosed herein.

FIG. 7A illustrates an exemplary screenshot of the system of FIG. 1 as shown on a mobile device, in accordance with embodiments disclosed herein.

FIG. 7B illustrates an exemplary screenshot of the system of FIG. 1 as shown on a computing device, in accordance with embodiments disclosed herein.

FIG. 8A illustrates an exemplary screenshot of the system of FIG. 1 as shown on a mobile device, in accordance with embodiments disclosed herein.

FIG. 8B illustrates an exemplary screenshot of the system of FIG. 1 as shown on a computing device, in accordance with embodiments disclosed herein.

FIG. 9A illustrates an exemplary screenshot of the system of FIG. 1 as shown on a mobile device, in accordance with embodiments disclosed herein.

FIG. 9B illustrates an exemplary screenshot of the system of FIG. 1 as shown on a computing device, in accordance with embodiments disclosed herein.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

### Terminology

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “a first actionable element,” may be made. However, the specific numeric reference should not be interpreted as a literal sequential order but rather interpreted that the “first actionable element” is different than a “second actionable element.” Thus, the specific details set forth are merely exemplary. The specific details may be varied from and still be contemplated to be within the spirit and scope of the present disclosure. The term “coupled” is defined as meaning connected either directly to the component or indirectly to the component through another component, where the connection may enable communications between these components.

As used herein, the term “communication” generally refers to related data that is received, transmitted, or exchanged within a communication session. The data may include a plurality of packets, where a “packet” broadly refers to a series of bits or bytes having a prescribed format. Alternatively, the data may include a collection of data that may take the form of an individual or a number of packets carrying related payloads, e.g., a single webpage received over a network. Further, as used herein, the terms “about,” “approximately,” or “substantially” for any numerical values or ranges indicate a suitable dimensional tolerance that allows the part or collection of components to function for its intended purpose as described herein.

In the following description, certain terminology is used to describe features of the invention. For example, in certain situations, the term “logic” is representative of hardware, firmware and/or software that is configured to perform one or more functions. As hardware, logic may include circuitry having data processing or storage functionality. Examples of such circuitry may include, but are not limited or restricted to a microprocessor, one or more processor cores, a programmable gate array, a microcontroller, a controller, an application specific integrated circuit (“ASIC”), wireless receiver, transmitter and/or transceiver circuitry, semiconductor memory, or combinatorial logic.

Alternatively, logic may be software, such as executable code in the form of an executable application, an Application Programming Interface (API), a subroutine, a function, a procedure, an applet, a servlet, a routine, source code, object code, a shared library/dynamic load library, or one or more instructions. The software may be stored in any type of a suitable non-transitory storage medium, or transitory storage medium (e.g., electrical, optical, acoustical, or other form of propagated signals such as carrier waves, infrared signals, or digital signals). Examples of a non-transitory storage medium may include, but are not limited or restricted to a programmable circuit; semiconductor memory; non-persistent storage such as volatile memory (e.g., any type of random access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device. As firmware, the executable code may be stored in persistent storage.

The term “computing device” may be construed as electronics with data processing capabilities and/or a network interface capabilities, such as network connectivity to a physical or virtual network such as a public network (e.g., Internet), a private network (e.g., a wireless data telecommunication network, a local area network “LAN”, etc.), a public cloud network, a virtual private cloud, of the like. Examples of a computing device may include, but are not limited or restricted to, the following: a server, an endpoint device (e.g., a laptop, a smartphone, a “wearable” device, a smartwatch, a tablet, a desktop or laptop computer, a netbook, or any general-purpose or special-purpose, user-controlled electronic device); a mainframe; a router; or the like.

The term “network” may include a public and/or private network based on wired or wireless interconnects and in a centralized or decentralized configuration. The networks may include, but are not limited or restricted to a Local Area Network (LAN), a Wireless Local Area Network (WLAN), a Virtual Private Network (VPN), intranet, internet, ‘cloud’ based network, or similar network configurations.

A “message” generally refers to information transmitted in one or more electrical signals that collectively represent electrically stored data in a prescribed format. Each message may be in the form of one or more packets, frames, HTTP-based transmissions, or any other series of bits having the prescribed format.

The term “computerized” generally represents that any corresponding operations are conducted by hardware in combination with software and/or firmware.

As used herein, “personal information” can include, but not limited to name, address, phone number, e-mail address, usernames, social security number (SSN), tax identification number (TIN), driver's license, passport, government identification numbers or the like.

As used herein, “financial information” can include, but not limited to income, expenditures, assets, liabilities, credit scores, bank accounts, credit cards, mortgages, car loans, personal loans, or the like.

As used herein, one or more logic or computing devices can use predetermined rule sets or weightings, machine learning models, or other artificial intelligence (“AI”) schemes not limited by the present disclosure, such as artificial neural networks, supervised classification methods, logistic regression or other linear classifiers, support vector machines, quadratic classifiers, kernel estimation, decision trees, neural networks, convolutional neural networks, trained machine learning models, learning vector quantization, or the like.

It is important to note that any company names, firms, logos, and/or websites used herein are exemplary.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition may occur only when a combination of elements, functions, steps or acts are in some way inherently mutually exclusive.

### Exemplary System Architecture

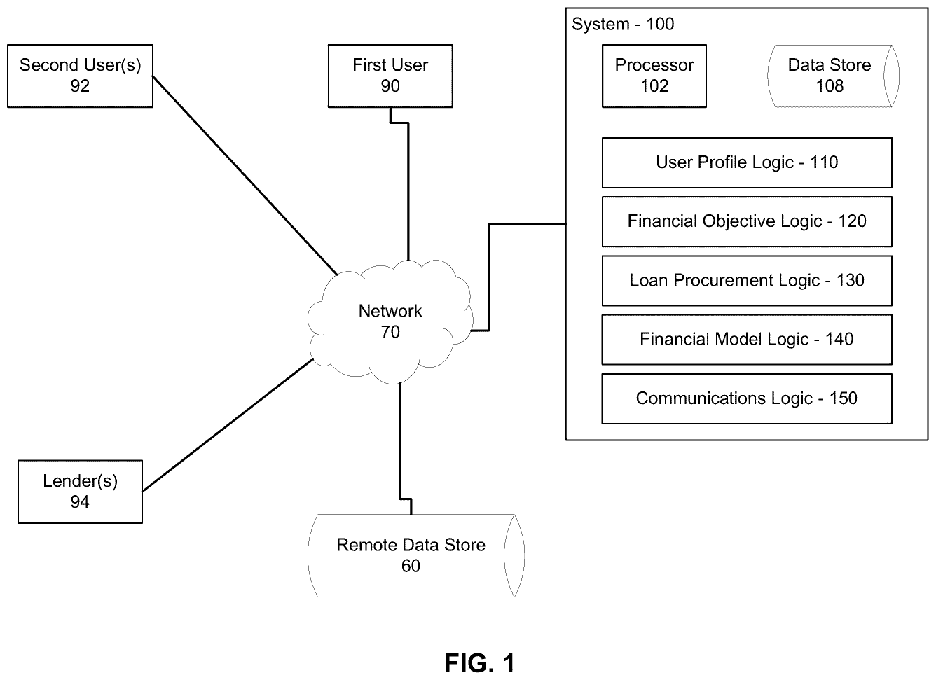

FIG. 1 shows a schematic view of a loan access system (“system”) 100 configured to determine a financial model for a first user (“user”) 90 that can map out a journey for the user 90 from their current financial situation to a future financial situation and on to achieve their financial objectives. The system 100 may include one or more computing devices, such as a server, which is communicatively coupled, either directly or indirectly, with other computing devices such as, for example, a first user computing device (“first user”) 90, one or more second user computing device(s) (“second user”) 92 that are unrelated to the first user, and a lender 94 computing device (“lender”) 94.

Each of the computing devices 100, 90, 92, 94 may be communicatively coupled, either directly or indirectly, through a network 70. As shown, the system 100 may be deployed as a physical server, including a one or more processors 102 and a non-transitory storage medium (e.g., memory) such as data store 108, configured to store one or more logic engines such as a user profile logic 110, a financial objective logic 120, a loan procurement logic 130, a financial model logic 140, and a communications logic 150. Alternatively, the system 100 may be deployed as a virtual server, namely software deployed within a public or private cloud network and operating as a physical server.

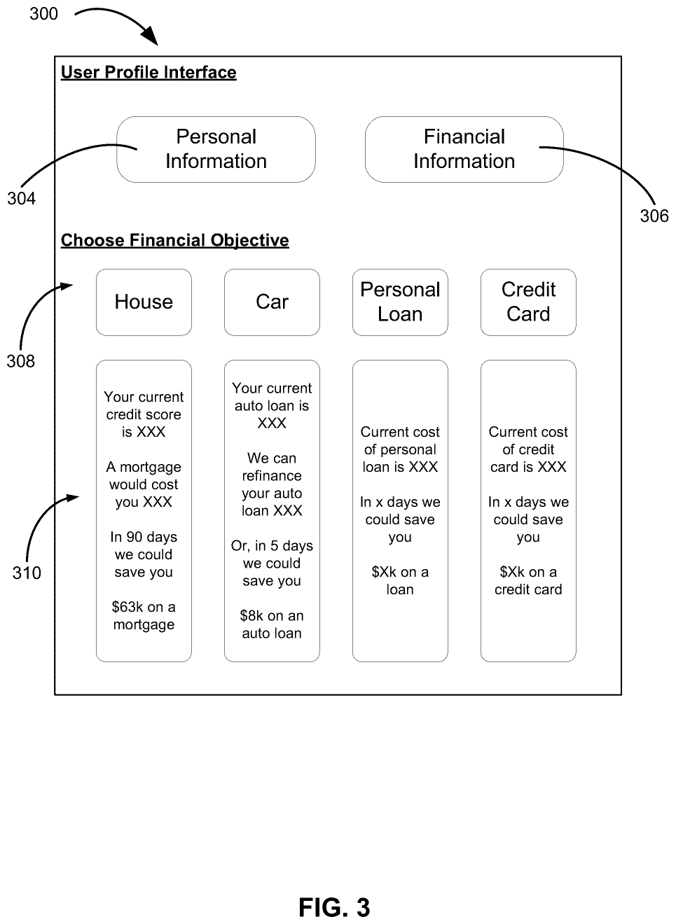

Herein, according to one embodiment of the disclosure, the user profile logic 110, as will be discussed in more detail herein, may include logic configured to perform the functions of providing a dynamically updatable user profile interface 300 (FIGS. 3, 6A-9B) configured to receive one or more inputs from the first user 90 such as personal information, financial information, and/or a selection of a financial objective. The user profile logic 110 can store the personal information or financial information as a user profile in data store 108. In an embodiment, the user profile logic 110 can be configured to provide one or more additional interfaces such as a personal information interface or a financial information interface configured to provide additional information about the user profile or receive an input from the user 90 to update the user profile information.

In an embodiment, the user profile logic 110 can be configured to provide one or more selection buttons 308 configured to receive an input from a user 90 to indicate a selection of a type of a financial objective type. As used herein a “financial objective” can be any significant objective that a user 90 is wanting to finance, or to refinance. Exemplary financial objective types can include a “house,” “car”, “personal loan,” “credit card” financial objectives. As will be appreciated other types of financial objectives are also contemplated to fall within the scope of the present invention.

In an embodiment, as shown in FIG. 3, the user profile logic 110 can be configured to provide one or more personalized examples 310 associated with a selection button 308. The personalized examples 310 can include one or more personal information or financial information about the user 90. Further, the personalized examples 310 can include potential savings by comparing the user's 90 personal information or financial information with that of one or more second user's 92 of the system, who are unrelated to the first user 90 and who have already generated financial models and have obtained similar savings, as described herein. As such, the user profile logic 110 can provide improved estimates of potential savings for the first user 90, depending on the type of financial objective selected. Advantageously, the personalized examples 310 can motivate a user 90 to use the system 100. Further the personalized examples 310 can motivate continued use of the system 100 based on the accuracy of the initial personalized examples 310.

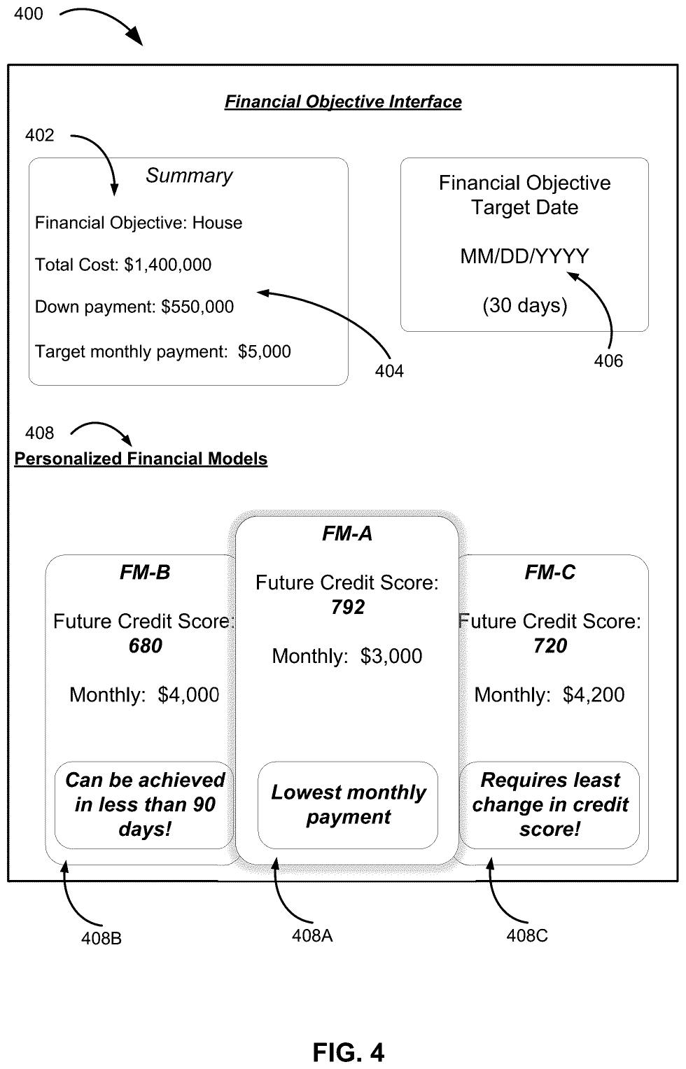

Herein, according to one embodiment of the disclosure, the financial objective logic 120, as will be discussed in more detail herein, may include logic configured to perform the functions of providing a dynamically updatable financial objective interface 400 (FIG. 4) configured to provide information about the type of financial objective selected and configured to receive one or more inputs from the user 90 including one or more financial objective parameters 404. The financial objective parameters 404 can include details about the financial objective that need to be met in order to obtain the financial objective. For example, as shown in FIG. 4, a “house” financial objective type can be selected by the user 90. The financial objective interface 400 can be configured to include one or more financial objective parameters 404, such as total cost of the house, the down payment amount, or a target monthly mortgage payment. Other exemplary financial objective parameters can include, but not limited to, a total value of the financial objective, a down payment amount, an annual percentage rate (% APR), an interest rate, a financial objective target date, a monthly payment, a principal payment, an interest rate payment, a maximum time to repay, a minimum payment, combinations thereof, or the like. As will be appreciated these are simplified parameters used for illustrative purposes and other pertinent information about the financial objective are also contemplated.

In an embodiment, the financial objective logic 120 can be configured to retrieve one or more of the financial parameters 404 from one or more remote data stores 60 or a third party, and can automatically update the financial objective interface 400. For example, the financial objective logic 120 can be configured to retrieve a mortgage interest rate, or details about a particular house, or the like. In an embodiment, the financial objective logic 120 can be configured to receive an address of a specific house that the user 90 would like for their financial objective. The financial objective logic 120 can then be configured to query one or more remote data stores 60 to retrieve additional information about the house, (e.g. current house price, property tax, etc.). In an embodiment, a user 90 can enter a location, city, zip code, or the like as a financial objective parameter and can include a target home price, i.e. total cost parameter. The financial objective logic 120 can then be configured to query one or more remote data stores 60 to retrieve additional information about the location and retrieve one or more houses that are within a price range, within the location. In an embodiment, a user 90 can select a “car” financial objective type. The financial objective logic 120 can then be configured to receive a total cost of the car parameter, or a VIN number or license plate number parameter for a specific car, or a selection of a type of car (e.g. sedan, SUV, or truck, etc.), as a financial objective parameter. These and similar examples are considered to fall within the scope of the present invention.

In an embodiment, the financial objective logic 120 can provide estimated financial objective parameters 404 based on one or more second users 92 of the system 100 that have similar personal or financial information. The user 90 can then further modify the estimated financial objective parameters 404, as described herein. In an embodiment, the financial objective logic 120 can be configured to receive a target date 406, which can be a specific date, a date range, or a length of time until the user 90 wishes to apply for the financial objective. For example, a length of time (e.g. 30 days) until the user applies for the mortgage to finance the “house” financial objective.

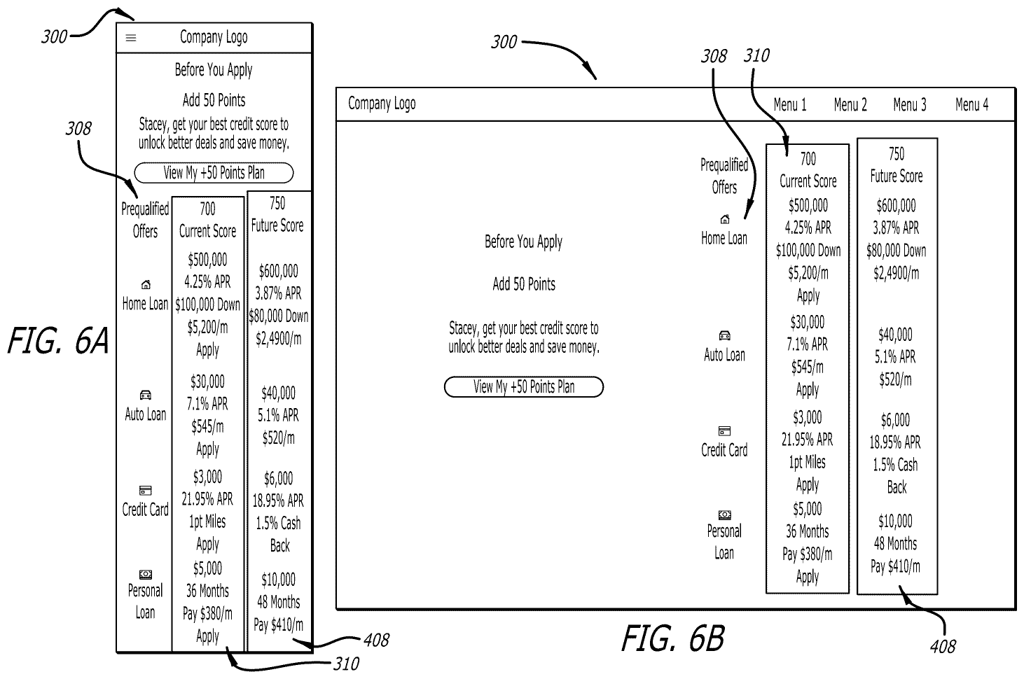

In an embodiment, the financial objective logic 120 can be configured to provide one or more financial models 408 included as part of the financial objective interface 400, or can be included as part of other interfaces, e.g. a user profile interface 300. In an embodiment, the financial model 408 can be represented as a symbol, an icon, or summary window. As shown in FIG. 4, the financial objective interface 400 can include three exemplary financial models, FM-A 408A, FM-B 408B, FM-C 408C. In an embodiment, the summary of the financial model 408 can include information from the user profile, information about the financial model, comparative information between the financial models, or the like. As shown in FIGS. 6A-9B, a financial model 408 can be provided for each of one or more financial objectives 308. Advantageously, these financial models 408 can be shown to the first user before the user 90 has selected a financial objective 308 or modified any financial objective parameters 404 and can indicate to the user 90 what can be possible using the system 100. This can further motivate the user 90 to use the system 100.

In an embodiment, the financial model 408 can be dynamically updatable based on the user 90 entering one or more financial objective parameters 404. For example, as the user 90 modifies one of the total cost, down payment, or monthly payment parameters 404, the financial objective logic 120 can provide different financial models 408 or modify existing financial models 408. In an embodiment, the financial objective logic 120 can retrieve new financial models from the financial model logic 140 as the user 90 modifies the financial objective parameters 404. In an embodiment, the financial model logic 140 can modify existing financial models 408 as the user 90 modifies the financial objective parameters 404.

In an embodiment, the financial objective logic 120 can reposition the financial model 408 within the financial objective interface 400 based on the modification of the financial objective parameters 404. For example, the financial objective logic 120 can position a first financial model (FM-A) 408A that best meets the financial objective parameters 404 in a more prominent position, relative to other possible financial models, e.g. FM-B 408B, FM-C 408C.

In an embodiment, the financial objective logic 120 can position a financial model 408 proximate the parameter 404 that is best fulfilled by the financial model 408. For example, where the first financial model 408A provides a lowest monthly payment, the financial objective logic 120 can position the first financial model 408A proximate the monthly payment parameter 404. Similarly, a second financial model 408 may require the lowest down payment, as such the financial objective logic 120 can position the second financial model 408B proximate the down payment parameter 404. As such, the financial objective logic 120 can quickly indicate to a user 90 which financial model 408 is best suited to fulfil a particular parameter 404, and the user 90 can quickly identify which financial model 408 suits their preferences without having to compare specific details of the financial model 408.

Herein, according to one embodiment of the disclosure, a loan procurement logic 130, as will be discussed in more detail herein, may include logic configured to perform the functions of querying one or more remote databases 60 and/or lender computing devices 94 to retrieve one or more predetermined loan products. The loan procurement logic 130 can be configured to retrieve one or more of the financial objective type 402, and the associated parameters 404 and select one or more loans that can fulfill the financial objective parameters 404. In an embodiment, the loan procurement logic 130 can be configured to retrieve one or more of the financial objective type 402 and the associated parameters 404 and establish an auction platform configured to receive bids from one or more lenders 94 to provide a loan to fulfil the financial objective parameters 404.

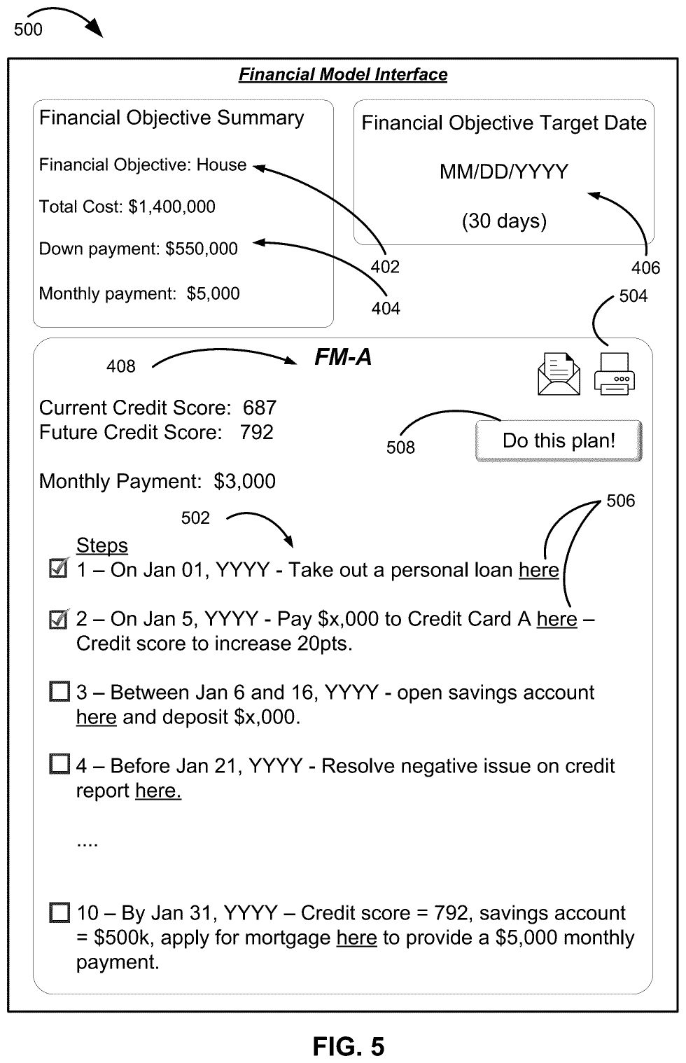

Herein, according to one embodiment of the disclosure, the financial model logic 140, as will be discussed in more detail herein, may include logic configured to perform the functions of providing a financial model interface 500 (FIG. 5), including details of a selected financial model 408. The financial model logic 140 can be configured to retrieve one or more of the financial objective type 402, associated parameters 404, and one or more loans from the loan procurement logic 130 and determine if and how the user's financial information needs to change in order to qualify for the loan and/or fulfill the financial objective parameters 404. For example, the financial model logic 140 can determine that the user 90 can qualify for the loan and/or fulfill the financial objective parameters 404 by changing one or more of the user's current incomes, expenditures, assets, liabilities, and credit scores, or combinations thereof, to a future predetermined income, expenditure, asset, liability, or credit score, etc. The financial model logic 140 can then determine a financial model 408 including one or more action steps 502. The action steps 502 can include specific actions, in a specific order, and to be carried out within a predetermined time window in order to modify the user's current financial information to a future, predetermined financial information.

In an embodiment, the financial model logic 140 can use predetermined rule sets and weightings, machine learning, neural networks, or artificial intelligence (AI) schemes to determine the financial model 408 from one or more previous financial objectives, associated parameters, and/or previous financial models implemented by the first user 90 and/or by one or more second users 92 of the system 100, different from the first user 90. Advantageously, the one or more previous financial objectives, associated parameters, and/or previous financial models implemented by the first user 90 or by one or more second users 92 can train the financial model logic 140 and to provide more accurate financial models 408.

For example, the financial model logic 140 can process labeled historical information including one or more current financial information, future financial information, financial objectives, associated parameters, and/or previous financial models, or action steps thereof, implemented by the first user 90 or by one or more second users 92 of the system 100 to train a machine learning model. The financial model logic 140 can generate feature vectors and assign weightings to these feature vectors. The financial model logic 140 can then review one or more current financial information, financial objectives, associated parameters, for the first user 90 and use to the trained machine learning model to extract feature vectors to determine a financial model to modify a current financial information to a future financial information for the user 90.

Herein, according to one embodiment of the disclosure, the communication logic 150, may include logic configured to perform the functions of providing communications, and/or sending or receiving messages or information to or from the system 100 with one or more computing devices 90, 92, 94, remote databases 60, or networks 70. In an embodiment, the communication logic 150, may include logic configured to perform the functions of providing communications, or sending or receiving messages or information between different components or logic of the system 100.

The data store 108, as will be discussed in more detail herein, may operate as persistent storage, such as a database configured to store information from, and provide information to the user profile logic 110, a financial objective logic 120, a loan procurement logic 130, a financial model logic 140, and a communications logic 150, or a combination thereof. It will be appreciated that other logic or databases, e.g. third party data store 60, can be communicatively coupled, either directly or indirectly, with the data store 108, without limitation.

In an embodiment, the logic described herein may rely on heuristics, machine learning, artificial intelligence (A.I.), neural networks, or other data processing techniques to perform the described functionality.

### Method of Use

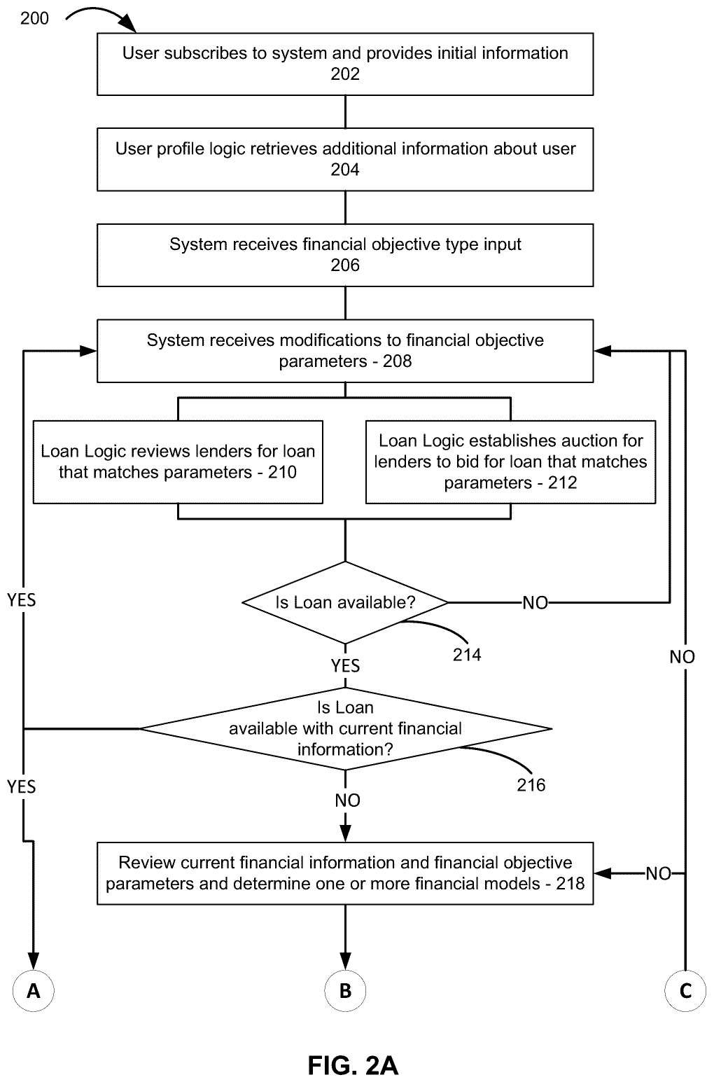

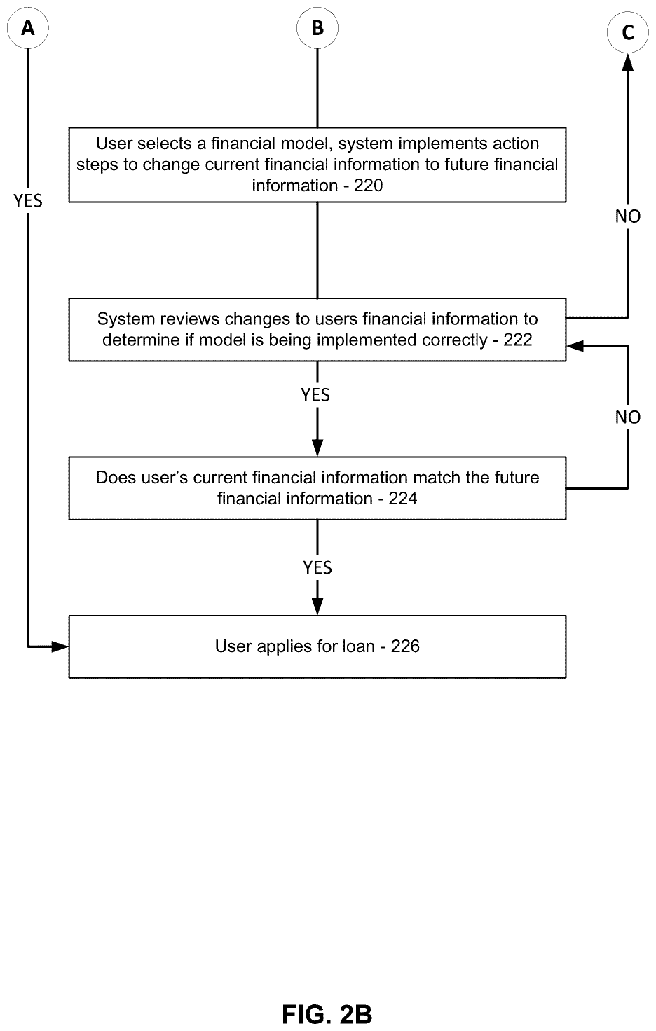

FIGS. 2A-2B show a flow chart for an exemplary method of use 200 for the system 100. FIGS. 3-9B show exemplary screen shots for the system 100. As shown in box 202 of FIG. 2A and generally in FIG. 3, the first user 90 can subscribe to the system 100 and enter initial information, for example personally identifiable information (PII), such as name, address, date of birth, e-mail address, social security number, or the like. In an embodiment, the first user 90 can pay a subscription fee or one-time access fee to access the system 100. Optionally, the system 100 may be included as part of a broader system that the first user 90 has already signed up to and provided an initial personal information, and/or paid a subscription fee or one-time access fee. Exemplary broader systems can include a credit score system, further details and embodiments of which can be found in U.S. Pat. No. 11,232,489 and U.S. Patent Publication 2020/0074546, each of which is incorporated by reference in its entirety.

In an embodiment, the user profile logic 110 can provide a dynamically updatable user profile interface 300 to the first user 90 to enter one or more PII or financial information. Exemplary PII can include name, email address, social security number (S.S.N.), or the like, that can be stored to the data store 108. Exemplary financial information can include income, expenditure, assets (house equity, car, savings, etc.), liabilities (loans, mortgages, etc.), or credit scores. In an embodiment, as shown in box 204, the user profile logic 110 can query additional remote databases 60, e.g. financial institutions, government databases, credit bureaus, or like, to retrieve additional personal information or financial information for the first user 90 to include in the user profile interface 300.

In an embodiment, the user profile interface 300 can include a summary of the user profile, e.g. a summary of personal information or financial information. In an embodiment, the user profile interface 300 can provide selection buttons to access additional personal or financial information. For example, a personal information selection button 304 can be configured to access full details of the personal information within the user profile that the system 100 has stored for the first user 90. A financial information selection button 306 can be configured to access a full profile of financial information for the first user 90, e.g. bank accounts, credit card accounts, assets (house values, car values, etc.), liabilities (loans, etc.) or credit scores. In an embodiment, the user 90 can review the personal or financial information for accuracy, and update the information within the system 100. The personal or financial information can either be stored locally in data store 108, and/or communicated to one or more remote databases 60.

In an embodiment, as shown in box 206 a financial objective logic 120 can be configured to receive a selection of a type of financial objective. Exemplary financial objectives types can include a house, car, boat, personal loan, business loan, credit card, or the like. For example, financial objective logic 120 can be configured to provide one or more financial objective selection buttons 308. In an embodiment the financial objective selection button 308 can be included as part of the user profile interface 300 or can be provided as a separate interface. It will be appreciated that the financial objective logic 120 can be configured to receive various forms of input to determine a selection of financial objective including text boxes, voice recognition inputs, radio buttons, check boxes, or the like. In an embodiment, each financial objective selection box 308 can be directed to a different type of financial objective, for example, a house, car, boat, personal loan, business loan, credit card, or the like. As will be appreciated, other types of financial objectives or combinations of financial objectives are also contemplated. In an embodiment, one or more financial objectives can be selected simultaneously, for example a car and a house can be selected together and system 100 can determine a financial model, as described herein, to achieve the combined financial objectives.

In an embodiment, as shown in FIGS. 3 and 6A-9B, the financial objective logic 120 can be configured to provide personalized examples 310 of potential savings available to the user 90. The financial objective logic 120 can review the user's personal and financial information for the user 90 and review previous financial models 408, created by the first user 90, or by one or more unrelated, second users 92 of the system 100 who have similar personal or financial information. Advantageously, the system 100 can provide accurate examples for the user 90, based on previous users with similar socio-economic or demographics as the user 90. This can motivate the user 90 for repeated use of the system 100 when the outcomes of the financial models 408 more closely match that of the initial expectations.

In an embodiment, as shown in box 208 and FIG. 4, once the user 90 has selected a financial objective type, the financial objective logic 120 can be configured to provide a financial objective interface 400. As will be appreciated, each financial objective interface can be directed to the specific type of financial objective, e.g. house, car, personal loan, credit card, or combinations thereof. The financial objective interface 400 can be configured to provide details about the financial objective type 402 and configured to receive additional parameters 404 about the financial objective. In an embodiment, the financial objective logic 120 can review the user 90's personal and/or financial information and provide estimated financial objective parameters 404. The financial objective logic 120 can be configured to receive an input from the user 90 where the user 90 can then modify these estimated financial objective parameters 404. Exemplary parameters 404 can include total cost amount, down payment amount, a target monthly payment, or the like.

In an embodiment, the financial objective logic 120 can apply a range surrounding the financial objective parameters 404, either as an absolute amount above or below the parameter, or as a percentage of the parameter. For example, where a total cost amount parameter is $1.4 m, the financial objective logic 120 can include a range of +/−$100,000, or a range of +/−10% of the total cost parameter, or the like. In an embodiment, a user 90 can modify the range surrounding the parameter(s) or provide a range for each parameter. In an embodiment, the financial objective logic 120 can further request a time window 406 within which to achieve the financial objective parameters 404, e.g. to achieve by a particular date or within a predetermined length of time (30 days).

In an embodiment, a loan procurement logic 130 can be configured to retrieve the financial objective type 402, and associated financial objective parameters 404, and query one or more lenders 94 for one or more loan products that can fulfill the financial objective parameters 404 and finance the financial objective. In an embodiment, as shown in box 210, the loan procurement logic 130 can retrieve one or more existing loan products. In an embodiment, as shown in box 212, the loan procurement logic 130 can establish an auction platform configured to receive one or more bids from one or more lenders 94 to provide one or more loan products.

In an embodiment, as shown at decision node 214, if no loan is available that can fulfill the financial objective parameters, the loan procurement logic 130 can request the user 90 to change the financial objective parameters 404 and/or can provide guidance to the user 90. For example, the system 100 can indicate that the total cost parameter needs to be reduced, the down payment parameter needs to be increased, or the maximum monthly payment parameter needs to be increased. In an embodiment, the system 100 can suggest parameters that are within range of one or more loan products. In an embodiment, the system 100 can prevent a user 90 from modifying the financial objective parameters outside of a range where a loan product would be unavailable to the user 90.

In an embodiment, as shown at decision node 216, where a loan is available and the user 90 is able to apply for the loan with their current financial information, the loan procurement logic 130 can request to proceed with the loan product (box 226). In an embodiment, the loan procurement logic 130 can return the user 90 to the financial objective interface 400 to modify the financial objective parameters 404. For example, the user 90 can increase the total cost, decrease the down payment, or reduce the total monthly payment for the financial objective. Advantageously, the system 100 can indicate to a user 90 which loans, and/or financial objectives can become available to the user 90 based on one or more financial models 408 and the resulting changes to the user's financial information. The user 90 would not be previously aware that these financial objectives could become available.

In an embodiment, as shown in box 218, where the loan product is not immediately available with the current financial information, the financial model logic 140 can review the financial information, review the financial objectives and associated parameters 404, and determine one or more financial models for the user 90. In an embodiment, the financial model logic 140 can provide the one or more financial models 408 within the financial objective interface 400 or can be configured to provide a separate interface.

As shown in FIGS. 4, 7A-7B, and 9A-9B, the financial objective interface 400 can further include one or more personalized financial models 408. Each of the financial model(s) 408 can modify the current financial information for the user 90 to a future financial information for the user 90 within the predetermined time window 406. Once the user 90 has achieved the future financial information, the user 90 can then apply for the loan, which was previously unavailable to the user 90, and can achieve the financial objective parameters 404. In an embodiment, the financial model logic 140 can dynamically modify the one or more financial models 408 provided, based on the modification of the parameters 404.

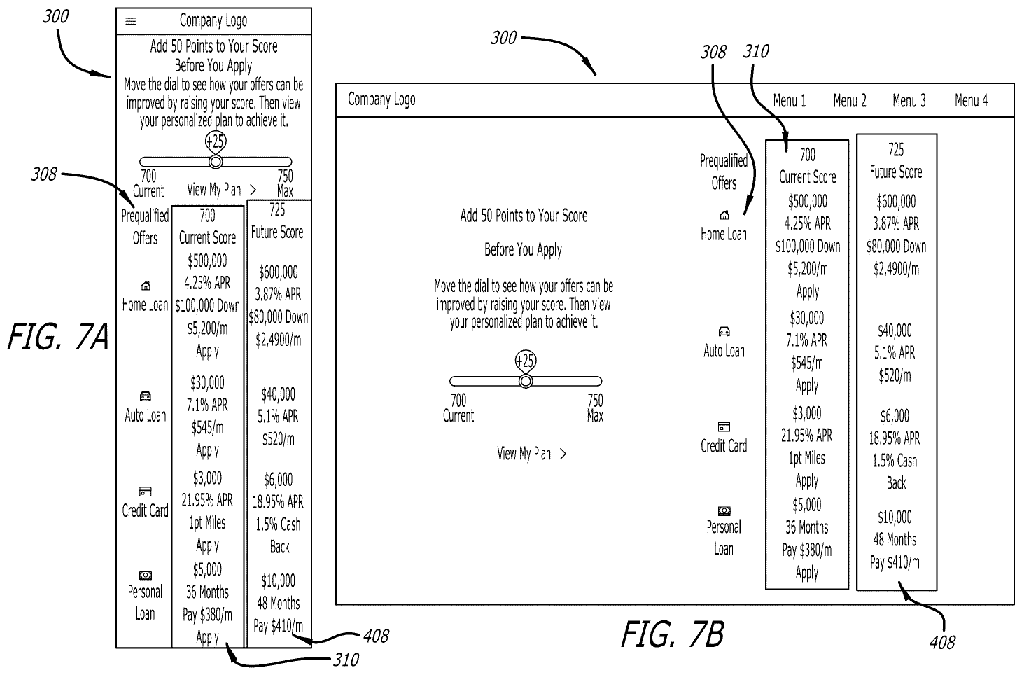

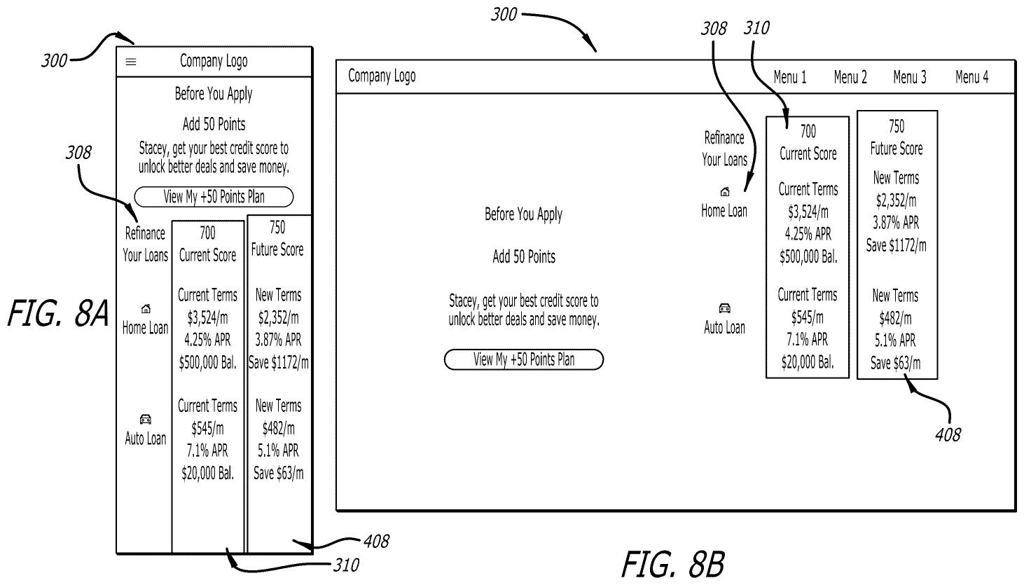

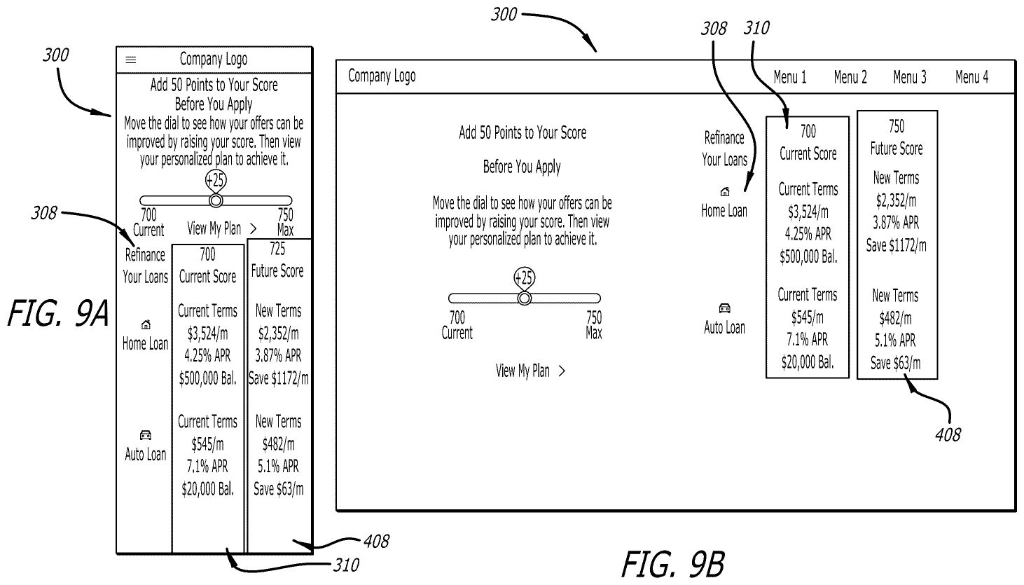

In an embodiment, the user 90 can modify one or more aspects of their financial information (e.g. current incomes, expenditures, assets, liabilities, or credit scores, etc.) to a future predetermined user financial information and the system 100 can provide one or more financial models 408 in response. For example, as shown in FIGS. 6A-6B and 8A-8B a user can select to modify a credit score by a given amount (e.g. +50 points). The given amount can be determined by the system 100 based on previous financial models 408 from the user 90 or one or more second users 92 of the system 100. The system 100 can then provide one or more financial models 408 based on this future financial information (i.e. on the basis of when the future credit score is achieved). For example, as shown in FIGS. 7A-7B and 9A-9B a user can select to modify a credit score or other financial information within a predetermined range (e.g. using a slider input to modify the credit score by between 0-50 points). The predetermined range can be determined by the system 100 based on previous financial models 408 from the user 90 or one or more second users 92 of the system 100. The system 100 can then provide one or more financial models 408 based on this future financial information (i.e. on the basis of when the new credit score is achieved). Further details and embodiments of which can be found in U.S. Pat. No. 11,232,489 and U.S. Patent Publication 2020/0074546, each of which is incorporated by reference in its entirety into this application.

In an embodiment, each of the financial models 408 can include a summary of information about the model. For example, as shown in FIG. 4, a first financial model, FM-A 408A, a second financial model, FM-B 408B, and a third financial model, FM-C 408C, can each include a future financial information, such as a future credit score that can be achieved by the user 90 by the target date 406 should the user 90 choose that particular financial model. Further, the summary information can include one or more financial objective parameters that will be fulfilled. For example, a monthly payment that will be within range of the monthly payment parameter, by the target date 406 should the user 90 choose that particular financial model. In an embodiment, each financial model 408 can include comparative information to identify how the financial model, e.g. a first financial model (FM-A) 408A differs from other financial models, e.g. a second financial model (FM-B) 408B or a third financial model (FM-C) 408C.

Advantageously, the financial objective logic 120 can dynamically update the financial objective interface 400 to modify the information (e.g. future financial information, financial objective parameters, comparative information, etc.) or the position of the one or more financial models 408 on the financial objective interface 400, as the user 90 modifies the parameters 404. The financial objective logic 120 can provide the most suitable predetermined financial model first, or in the most prominent position. In an embodiment, the financial objective logic 120 can position a financial model on the financial objective interface 400 proximate the financial objective parameter that it fulfills. For example, a first financial model that achieves a smaller monthly payment compared to a down payment can be positioned proximate the target monthly payment parameter input, a second financial model that achieves a smaller down payment compared to the monthly payment can be positioned proximate the down payment parameter input, or the like. Advantageously, where a user 90 has a preference between the financial objective parameters, the system can position the financial models on the interface to indicate which is best suited to a particular financial parameter, and the user 90 can quickly choose which financial model they would prefer without having to compare specific details of each financial model 408.

In an embodiment, as shown in box 220 and in FIG. 5, once the user 90 has updated the financial objective parameters 404, the user 90 can then select the financial model 408 that they prefer, e.g. select a first financial model (FM-A) 408A. In an embodiment, the financial model logic 140 can be configured to receive an input as to which financial model the user 90 has selected and can provide a financial model interface 500, including additional details of the financial model 408. The financial model 408 can include one or more actions 502 to be carried out in a predetermined order and each action to be carried out within a predetermined time window (e.g. on a date or within a date range). Exemplary actions can include pay off a credit card, open a savings account, moving an amount of money between accounts, consolidating one or more credit cards to an account, apply for a personal loan, resolve the negative issue on your credit report, or the like.

By carrying out the one or more actions 502 in the order that they are specified and on or within the specified time window, as indicated within the financial model 408, the current financial information for the user 90, e.g. one of current income, expenditures, assets, liabilities or credit score, can be modified to a future predetermined financial information, e.g. a future income, a future expenditure, a future assets, a future liabilities or a future credit score. Further the financial model can achieve the future, predetermined financial information within the predetermined time window 406 (e.g. 30 days, however it will be appreciated that greater or lesser time windows are also contemplated). When the user 90 has achieved the future financial information the user 90 can apply for a loan product to purchase the financial objective within the financial objective parameters.

By carrying out the one or more actions 502 of the financial model, the user 90 can modify their current financial information (e.g. current credit score or assets, etc.) to a future financial information (e.g. a future credit score or assets, etc.) that can allow the user to apply for a loan to finance the financial objective within the financial objective parameters 404. For example, provide a sufficient credit score, and/or sufficient down payment, to mortgage a financial objective of a house within the target monthly payment. To achieve the financial objective parameters 404, the user 90 may need to change their credit score, either to increase or decrease their credit score, to a particular score. To note a user 90 may need to change their credit score to a specific score that is within a credit score range. The credit score would then be within a range to achieve the loan product that was previously unavailable. Advantageously, when achieving a specified predetermined credit score, the system 100 prevents the user from spending assets unnecessarily that would otherwise be required, for example, for a down payment. In this way, the system 100 allows the user 90 to achieve their financial objective.

In an embodiment, the financial model logic 140 can determine the financial model 408 using machine learning or similar artificial intelligence schemes from one or more previous financial models, financial objectives, financial objective parameters, or loan products from the first user 90 or from one or more second users 92. The financial model logic 140 can store the personal information, financial information, previous financial models, associated financial objectives, financial objective parameters, and loan products. The financial model logic 140 can determine the accuracy of the financial model in achieving the financial objective parameters for one or more second users 92. The financial model logic 140 can then improve the accuracy of the financial model for the first user 90. Further, the financial model logic 140 can improve the accuracy of the financial model for the first user 90, from one or more second users 92, while maintaining the privacy of both the first user 90 and the one or more unrelated, second users 92.

In an embodiment, the financial model logic 140 can be configured to send details of the financial model to the user 90 computing device to implement the financial model 408. The user can print or email 504 the actions 502 within the financial model 408. In an embodiment, the financial model logic 140 can provide a dynamically updatable interface 502 configured to receive an input from the user 90 to indicate whether or not an action 502 has been completed. The financial model logic 140 can review the actions 502 completed and review any changes in the user's 90 financial information to determine if the action 502 has been carried out correctly, and/or the action 502 had the intended effect on the user's financial information 90.

In an embodiment, as shown in FIG. 5, the financial model can include one or more hyperlinks 506 associated with an action step 502 of the financial model 408 and configured to provide semi-autonomous implementation of the financial model 408. The hyperlinks 506 can provide access to the user 90 to one or more third parties to carry out the action step 502. The third party can be a bank, credit card company, or similar financial institution. The user 90 may already be a client of the financial institution or be a new client to the financial institution. For example, where an action step requires to pay an amount to a credit card, the hyperlink can connect the user 90 with the credit card company to pay the credit card. In an embodiment, the hyperlink can connect the user to a third party marketplace where a user can shop through different products (credit cards, savings accounts, loan products, or the like) in order to carry out the step. Advantageously, the hyper link(s) 506 of the financial model interface 500 can provide a quick and convenient way of actioning the action step 502.

In an embodiment, the financial model interface 500 can include an implementation action button 508 configured to be actioned by the user 90 to indicate to the system 100 to autonomously implement every step 502 of the financial model 408. A user 90 can review each action 502 of the financial model 408 and if the user 90 agrees with the financial model 408 the user 90 can action the implementation button 508 to indicate to the system 100 to carry out each step of the financial model at the appropriate time. Advantageously, by autonomously implementing the financial model the system 100 does not require any further input from the user 90 to carry out the financial model 408 and modify the financial information of the user 90. This provides an increased likelihood of success by removing human error from the implementation process.

In the embodiment shown in box 222, once the financial model 408 has been implemented the financial model logic 140 can be configured to review the financial information of the user 90 to determine if the steps of the financial model are being implemented correctly and if the steps are having the intended effect on the user's 90 financial information. If the not, the financial model logic 140 can return to box 218 and review and modify the financial model 408 or provide a different financial model 408. In an embodiment, system 100 can return to box 208 and request the user 90 to review or modify the financial objective parameters 404.

In an embodiment, where a user's financial information is changing as expected the system 100 can review the user's current financial information to determine if it matches the future, predetermined financial information (box 224). If it does not then the system returns to box 222. If it does then the financial model 408 has been completed successfully and the user 90 can apply for the loan that was previously inaccessible (box 226). In an embodiment, the system 100 can provide updates, tips, advice, or motivation at periodic intervals during the target time window (30 days) to maintain commitment to the plan by the user 90.

As will be appreciated this is a simplified example for illustrative purposes and embodiments of the system 100 can be used for various financial objectives, for example, an auto loan for a car, a personal loan for a building project, financing a boat, RV, or other large expense, applying for a credit card with particular benefits, or the like. Advantageously, the system 100 can review personal and financial information, review one or more loan products and determine not only loan products that are currently available to the user 90, but also loan products that can become available to the user 90 by changing certain aspects of their personal or financial information. The system 100 can provide loan products that the user 90 would otherwise be unaware would be available, or be inaccessible to the user 90, since the loan providers would not offer these products based on the users current personal or financial information. Advantageously, the system can determine that these loan products are possible by the user 90 based on previous user financial models 408 or from other users 92 of the system 100 with similar situations. This can allow a user 90 to access previously inaccessible loan products and obtain financial objectives that was previously inaccessible to the user.

While the invention has been described in terms of particular variations and illustrative figures, those of ordinary skill in the art will recognize that the invention is not limited to the variations or figures described. The features described with respect to one embodiment or variation may be used in other embodiments or variations. Processes described separately may be combined. In addition, where processes and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

1. A computerized method, comprising:
generating a graphical user interface (GUI) displaying parameters of a financial objective and a plurality of financial model icons, wherein each of the plurality of financial model icons lists a credit score and a corresponding payment;
receiving, by the GUI, user input modifying a first parameter of the financial objective;
dynamically updating one or more of the plurality of financial model icons; and
altering the GUI based on the dynamically updating of the one or more of the plurality of financial model icons resulting in an adjustment of a positioning of a first financial model icon.

2. The computerized method of claim 1, wherein the adjustment of the positioning of the first financial model icon includes positioning the first financial model icon to be proximate the first parameter, wherein an advantage provided by a first financial model represented by the first financial model icon corresponds the first parameter.

3. The computerized method of claim 1, wherein the adjustment of the positioning of the first financial model icon includes positioning the first financial model icon in a more visibly prominent position relative to a remaining subset of the plurality of financial model icons.

4. The computerized method of claim 1, wherein each of a plurality of financial models represented by the plurality of financial model icons correspond to one or more action steps, that when carried out within a predetermined time window, result in modification of a credit score of an individual.

5. The computerized method of claim 4, wherein the plurality of financial models are determined by a machine learning model or artificial intelligence schema that are trained on previous financial objectives, associated parameters, and historical financial models of the individual or one or more secondary individuals.

6. The computerized method of claim 5, wherein personally identifiable information (PII) is automatically removed information from the previous financial objectives, the associated parameters, and the historical financial models of the one or more secondary individuals before the data is used in training of the machine learning model.

7. The computerized method of claim 4, wherein the financial objective refers to purchasing a house, the parameters include a total cost of the house, a downpayment, a monthly payment, and a target date, and updating the GUI includes displaying the first financial model icon in a visibly protruding manner relative to a remaining subset of the plurality of financial model icons.

8. A non-transitory computer readable medium having stored thereon instructions that, when executed by one or more processors, cause the one or more processor to perform operations including:
generating a graphical user interface (GUI) displaying parameters of a financial objective and a plurality of financial model icons, wherein each of the plurality of financial model icons lists a credit score and a corresponding payment;
receiving, by the GUI, user input modifying a first parameter of the financial objective;
dynamically updating one or more of the plurality of financial model icons;
altering the GUI based on the dynamically updating of the one or more of the plurality of financial model icons resulting in an adjustment of a positioning of a first financial model icon.

9. The non-transitory computer readable medium of claim 8, wherein the adjustment of the positioning of the first financial model icon includes positioning the first financial model icon to be proximate the first parameter, wherein an advantage provided by a first financial model represented by the first financial model icon corresponds the first parameter.

10. The non-transitory computer readable medium of claim 8, wherein the adjustment of the positioning of the first financial model icon includes positioning the first financial model icon in a more visibly prominent position relative to a remaining subset of the plurality of financial model icons.

11. The non-transitory computer readable medium of claim 8, wherein each of a plurality of financial models represented by the plurality of financial model icons correspond to one or more action steps, that when carried out within a predetermined time window, result in modification of a credit score of an individual.

12. The non-transitory computer readable medium of claim 11, wherein the plurality of financial models are determined by a machine learning model or artificial intelligence schema that are trained on previous financial objectives, associated parameters, and historical financial models of the individual or one or more secondary individuals.

13. The non-transitory computer readable medium of claim 12, wherein personally identifiable information (PII) is automatically removed information from the previous financial objectives, the associated parameters, and the historical financial models of the one or more secondary individuals before the data is used in training of the machine learning model.

14. The non-transitory computer readable medium of claim 11, wherein the financial objective refers to purchasing a house, the parameters include a total cost of the house, a downpayment, a monthly payment, and a target date, and updating the GUI includes displaying the first financial model icon in a visibly protruding manner relative to a remaining subset of the plurality of financial model icons.

15. A computing device, comprising:
a processor; and
a non-transitory computer-readable medium having stored thereon instructions that, when executed by the processor, cause the processor to perform operations including:
generating a graphical user interface (GUI) displaying parameters of a financial objective and a plurality of financial model icons, wherein each of the plurality of financial model icons lists a credit score and a corresponding payment;
receiving, by the GUI, user input modifying a first parameter of the financial objective;
dynamically updating one or more of the plurality of financial model icons;
altering the GUI based on the dynamically updating of the one or more of the plurality of financial model icons resulting in an adjustment of a positioning of a first financial model icon.

16. The computing device of claim 15, wherein the adjustment of the positioning of the first financial model icon includes positioning the first financial model icon to be proximate the first parameter, wherein an advantage provided by a first financial model represented by the first financial model icon corresponds the first parameter.

17. The computing device of claim 15, wherein the adjustment of the positioning of the first financial model icon includes positioning the first financial model icon in a more visibly prominent position relative to a remaining subset of the plurality of financial model icons.

18. The computing device of claim 15, wherein each of a plurality of financial models represented by the plurality of financial model icons correspond to one or more action steps, that when carried out within a predetermined time window, result in modification of a credit score of an individual.

19. The computing device of claim 18, wherein the plurality of financial models are determined by a machine learning model or artificial intelligence schema that are trained on previous financial objectives, associated parameters, and historical financial models of the individual or one or more secondary individuals.

20. The computing device of claim 19, wherein personally identifiable information (PII) is automatically removed information from the previous financial objectives, the associated parameters, and the historical financial models of the one or more secondary individuals before the data is used in training of the machine learning model.

21. The computing device of claim 20, wherein the financial objective refers to purchasing a house, the parameters include a total cost of the house, a downpayment, a monthly payment, and a target date, and updating the GUI includes displaying the first financial model icon in a visibly protruding manner relative to a remaining subset of the plurality of financial model icons.
